(19) United States
(12) Patent Application Publication
(10) Pub. No.: US 2011/0246357 A1
(43) Pub. Date: Oct. 6, 2011

(54) CHARGEBACK RESPONSE TOOL

(76) Inventors: Edward A. Young, Orem, UT (US); Parag Shah, Sunnyvale, CA (US); Kyle Smith Rose, West Jordan, UT (US); Dallas Rowsell, San Jose, CA (US); Michael De Angelis, Murray, UT (US); Joseph F. Kempton, Salt Lake City, UT (US); Issac Navanick, Salt Lake City, UT (US)

(21) Appl. No.: 12/752,011

(22) Filed: Mar. 31, 2010

(51) Int. Cl. G06Q 40/00

(52) U.S. Cl. 705/39

(57) ABSTRACT

A method and a system of a chargeback response tool. A chargeback response tool receives chargeback data from a financial vendor and automatically retrieves chargeback dispute evidence relating to the parties involved in the chargeback and about the original transaction from a transaction system that facilitated the original transaction. The chargeback response tool organizes and presents chargeback dispute evidence. The chargeback response tool may also analyze the performance and effectiveness of agents using the tool and of various approaches of disputing chargebacks.

### TECHNICAL FIELD

The present application relates generally to the technical field of computerized information and management systems and, in one specific example, to a chargeback response tool.

### BACKGROUND

The use of a payment instrument, such as a credit or debit card, is prevalent when transacting with online vendors or through online markets where transfer of money does not occur in person. Payment instruments may allow for a chargeback of a transaction which results in return of the money to an account of the payment instrument. Chargebacks may reduce revenue and utility of online markets and vendors. To avoid such negative effects, online vendors and markets may contest the chargeback by providing supplemental evidence to dispute the chargeback. Prior art systems to dispute chargebacks include manual processes and time consuming data collection efforts.

### BRIEF DESCRIPTION OF THE DRAWINGS

Various ones of the appended drawings merely illustrate example embodiments of the present invention and cannot be considered as limiting its scope.

FIG. 1A is a block diagram illustrating the flow of money in a purchase transaction, according to an example embodiment.

FIG. 1B is a block diagram illustrating the flow of money in a chargeback transaction, according to an example embodiment.

FIG. 1C is a block diagram illustrating the flow of money in a successfully disputed chargeback transaction, according to an example embodiment.

FIG. 2 is a block diagram of a chargeback response tool environment, according to an example embodiment.

FIG. 3 is a block diagram of a business logic system of the chargeback response tool, according to an example embodiment.

FIG. 4A is a process diagram illustrating generation of a dispute file, according to an example embodiment.

FIG. 4B is a process diagram illustrating an auditing and analytical process of a chargeback response tool, according to an example embodiment.

FIG. 5 is an interaction diagram illustrating an operation of a chargeback response tool, according to an example embodiment.

FIG. 6 is an example screenshot of a chargeback response tool providing chargeback dispute evidence to generate a chargeback dispute file.

FIG. 7 is an example screenshot of a chargeback response tool presenting a queue of chargebacks for an agent to address.

FIG. 8 is an example screenshot of a chargeback response tool presenting an agent auditing function.

FIG. 9 is an example screenshot of a chargeback response tool presenting the details of a chargeback case.

FIG. 10 is an example screenshot of a chargeback response tool presenting agent auditing information.

FIG. 11 is a block diagram of a machine in the example form of a computer system within which a set of instructions for causing the machine to perform one or more of the methodologies discussed herein may be executed.

### DETAILED DESCRIPTION

Example methods and systems of a chargeback response tool are described. In the following description, for purposes of explanation, numerous specific details are set forth in order to provide a thorough understanding of example embodiments. It will be evident, however, to one skilled in the art that the present invention may be practiced without these specific details. As used herein, the term “or” may be construed in an inclusive and exclusive sense.

Online systems, vendors, auction sites, marketplaces and other parties involved in transactions where payment instruments, such as credit and debit cards, are a method of exchanging money, may be subject to chargebacks that disrupt the intended functionality of services, frustrate utility, and negatively impact revenue. Such chargebacks may be initiated by a party possessing the payment instrument for reasons such as fraud or mistake. However, parties involved in the transaction, such as the party originally intended to receive the funds prior to the chargeback, an online vendor or market, or the holder of the payment instrument, may provide evidence to dispute the chargeback.

In an example embodiment of the present invention, a chargeback response tool may receive chargeback data from a financial vendor and automatically perform queries across multiple systems and databases of an online vendor or marketplace to collect relevant chargeback dispute evidence. The chargeback response tool may also utilize templates to generate a chargeback dispute template and populate the chargeback dispute template with chargeback data and chargeback dispute evidence, thus reducing manual data collection. The chargeback dispute template may be a template describing how the chargeback response tool should query for and present gathered chargeback dispute evidence. Agents may review and modify the chargeback dispute template. The chargeback dispute template is used in generating a chargeback dispute file. Agents may operate the chargeback response tool to inspect and amend the chargeback dispute template, select relevant dispute evidence, convert the chargeback dispute template to a chargeback dispute file, and communicate the chargeback dispute file to a financial vendor.

In an example embodiment, the chargeback response tool may also receive dispute feedback from financial vendors in regards to the chargeback dispute file. The dispute feedback may indicate which chargebacks, if any, are successfully disputed and on what grounds the dispute is successful. The chargeback response tool may include auditing and reporting tools to analyze both effectiveness of a certain approach to disputing a chargeback (e.g., what data was most successful in disputing a chargeback from a particular vendor) and performance of agents utilizing the chargeback response tool.

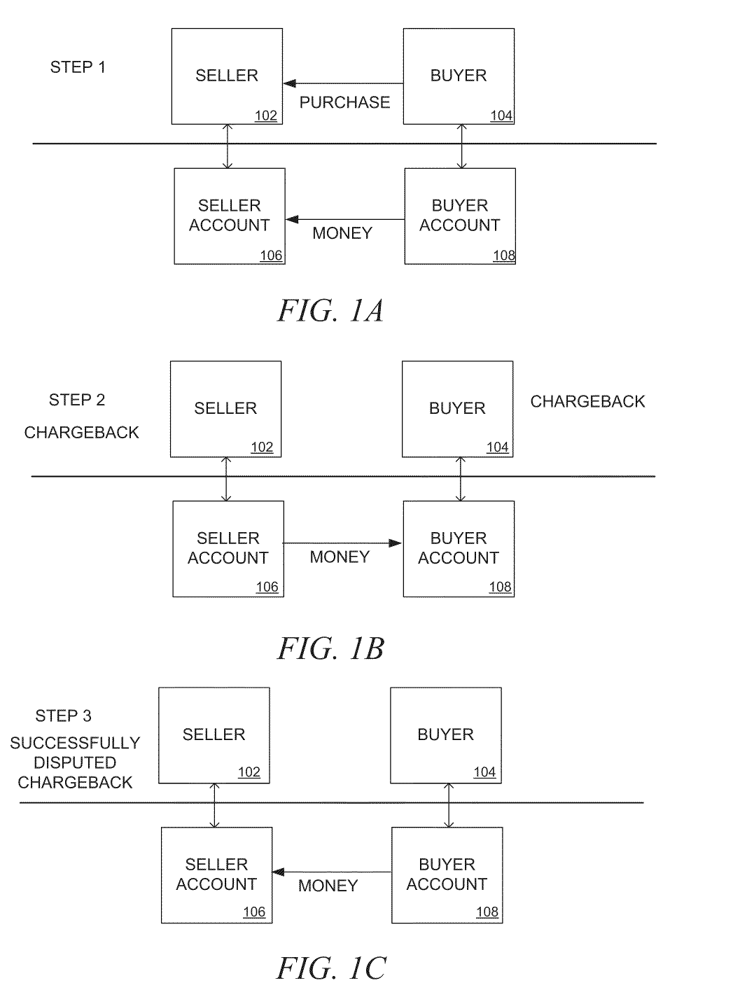

In order to fully understand example embodiments of the present invention, a discussion of a purchase transaction, a chargeback transaction, and a successfully disputed chargeback, as illustrated in FIG. 1A-FIG. 1C, follows.

FIG. 1A is a block diagram illustrating a flow of money in a purchase transaction, according to an example embodiment. A buyer 104 purchases an item or service from a seller 102. Accordingly, a buyer account 108 associated with the buyer 104 has some of its funds transferred to a seller account 106, which is associated with the seller 102. In an example embodiment, the buyer account is associated with a payment instrument. For example, one or more identifiers of the payment instrument may be stored in the buyer account.

FIG. 1B is a block diagram illustrating a flow of money in a chargeback transaction, according to an example embodiment. The chargeback transaction occurs after a purchase transaction, as described in FIG. 1A. The buyer 104 may initiate the chargeback transaction. In an example embodiment, the chargeback may be initiated when the buyer 104 reports to a bank or entity that issued the payment instrument used in the purchase transaction about fraud, a mistake, or other scenarios (e.g., identity theft or an unscrupulous merchant), which merit a chargeback. In response, the money originally sent from the buyer account 108 to the seller account 106 may be returned to the buyer account 108, effectively reversing the original purchase transaction.

FIG. 1C is a block diagram illustrating a flow of money in a successfully disputed chargeback transaction, according to an example embodiment. In response to the chargeback transaction, as exemplified in FIG. 1B, the seller 102 or another party involved in the purchase transaction, such as the buyer or a facilitating marketplace, may dispute the chargeback. A chargeback may be disputed by providing to the financial vendor, the bank, or the entity that issued the payment instrument, chargeback dispute evidence that the transaction was not a case of fraud, mistake, or other scenarios that merit a chargeback. If the chargeback is successfully disputed, money from the buyer account 108 is returned to the seller account 106 as if the chargeback did not occur. Alternatively, upon successfully initiating a dispute against a chargeback, the money from a buyer account 108 may be placed into an intermediate account, pending the resolution of the chargeback dispute.

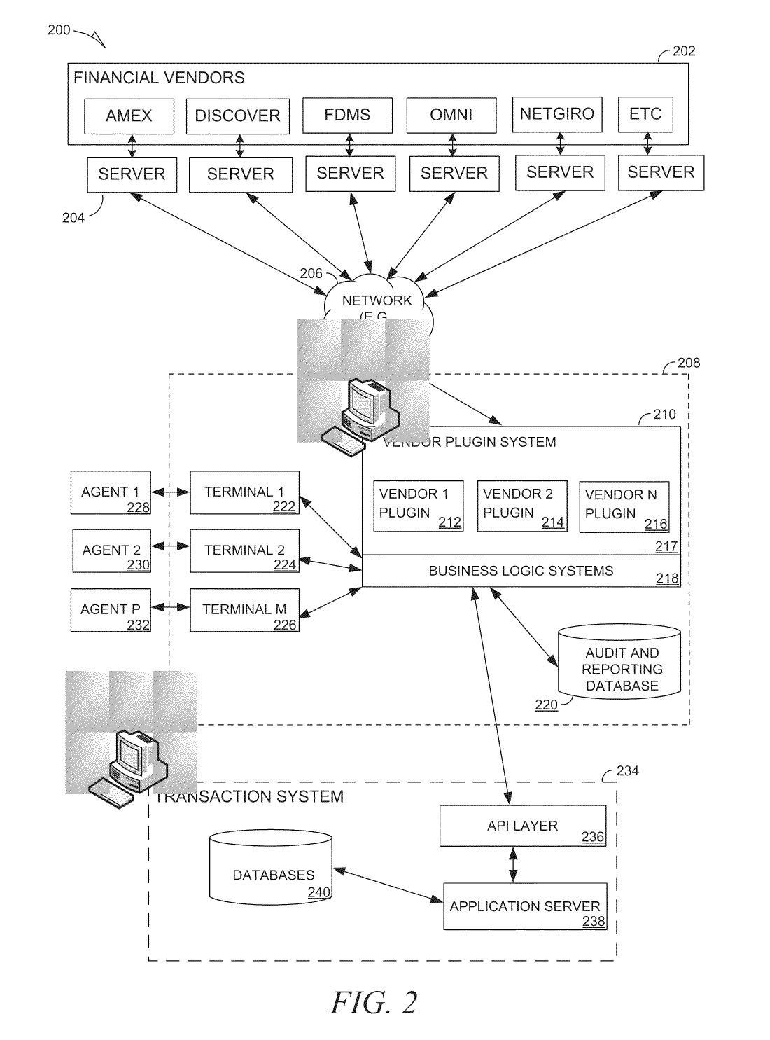

FIG. 2 is a block diagram of a chargeback response tool environment 200, according to an example embodiment. A chargeback response system 208 receives chargeback data from various financial vendors 202. Financial vendors 202 may include, but are not limited to, American Express, Discover, FDMS, OmniPay, NetGiro, other service payment providers, issuing banks, or entities that may authorize chargebacks. Each financial vendor 202 may have an associated vendor server 204. The vendor server 204 may be a web server, FTP server, API server, or another type of machine, computer, or software system coupled to a network 206, such as the Internet or an intranet, over which chargeback data may be communicated to the chargeback response system 208. The chargeback data is received by a chargeback response application 210.

The chargeback response application 210 contains a vendor plugin system 217. The vendor plugin system 217 contains vendor plugins 212, 214, 216, up to a variable N number of plugins. The vendor plugins 212, 214, 216 may be configured for a specific vendor 202 or a vendor server 204 associated with the vendor 202. The vendor plugins 212, 214, 216 may receive or pull data from the vendor server 204 and read a format of the chargeback data.

In an example embodiment, the financial vendor 202 may allow a limited number of logins by the chargeback response system 208 to retrieve chargeback data. In this case, the chargeback response system 208 will login with a single account and retrieve data from the financial vendor 202 for access by multiple agents accessing the chargeback response system 208.

A business logic systems 218 of the chargeback response application 210 may analyze the chargeback data received by the vendor plugins 212, 214, 216. In an example embodiment, the business logic systems 218 will analyze each listed chargeback in the chargeback data and query a transaction system 234 for chargeback dispute evidence. The transaction system 234 may be an online vendor, online marketplace, payment infrastructure, auction system, payment system, a store, or a system that facilitates transactions. The transaction system 234 may operate on or over the Internet and may rely on computer systems to function. In an example embodiment, the chargeback response system 208 may be a system of the transaction system 234.

The business logic system 218 of the chargeback response application 210 may access the transaction system 234 through an API layer 236 which provides access to an application server 238. The application server 238 may host various applications and systems of the transaction system 234 and provide access to databases 240. The databases 240 may store the data to be used as chargeback dispute evidence.

In an example embodiment, the business logic systems 218 may parse the chargeback data to identify transacting parties and associated transactions. The business logic systems 218 may then query the transaction system 234 to retrieve chargeback dispute evidence related to an original purchase, such as data on the transacting parties and about the chargeback transaction. In a further embodiment, the business logic system 218 may attempt to identify the purchase transaction that was subject to the chargeback and retrieve information about that transaction from the transaction system 234. If the specific transaction cannot be identified with certainty, such as if only part of a transaction was subject to a chargeback, the business logic systems 218 may gather chargeback dispute evidence from the transaction system 234 for all transactions that potentially were subject to the chargeback. In addition, the business logic system 218 may also collect information about the parties of the transaction (e.g., reputation scores, past transaction, and account status). The business logic system 218 may generate a response to the chargebacks with the chargeback dispute evidence.

The business logic systems 218 may then organize and display the chargeback data and the chargeback dispute evidence via a terminal 222, 224, 226, up to a variable M number of terminals. The terminals 222, 224, 226 may be a machine or computer system that allows an agent 228, 230, 232, up to a variable P number, to interact with the chargeback response application 210. In an example embodiment, the business logic systems 218 may sanitize sensitive financial information from display. Because much of the data collected from the financial vendors 202 and the transaction system 234 contains financially sensitive or private information (e.g., social security number, credit card numbers), the business logic systems 218 may sanitize information so that no confidential data is displayed to the agent 228, 230, 232 through the terminal 222, 224, 226.

The agents 228, 230, 232 may access the chargeback response application 210 through the terminal 222, 224, 226, to provide additional input and generate a chargeback dispute response file from the chargeback dispute template. The agents 228, 230, 232 may determine what chargeback dispute evidence to include in the chargeback dispute file and whether to dispute a chargeback.

The chargeback dispute response file may be communicated to the financial vendor 202 via the vendor server 204 through the network 206. The financial vendor 202 may provide dispute feedback via the server 204 and the network 206 to the chargeback response system 208. In an example embodiment, the chargeback dispute file and dispute feedback may be communicated through email, fax, letter, FTP, website, or an API. Dispute feedback may indicate whether the chargeback is successfully disputed and for what reason the dispute is successful. In example embodiments, the dispute feedback is received by the vendor plugin system 217. The business logic systems 218 may analyze the received dispute feedback and store it in an audit and reporting database 220. Agent performance information may also be stored in the audit and reporting database 220. Agent performance data may be reported on the terminal 222, 224, 226 for later inspection. Agents 223, 230, 232 with authorized login credentials may access this agent performance data. The dispute feedback may also be analyzed and displayed on the terminals 222, 224, 226.

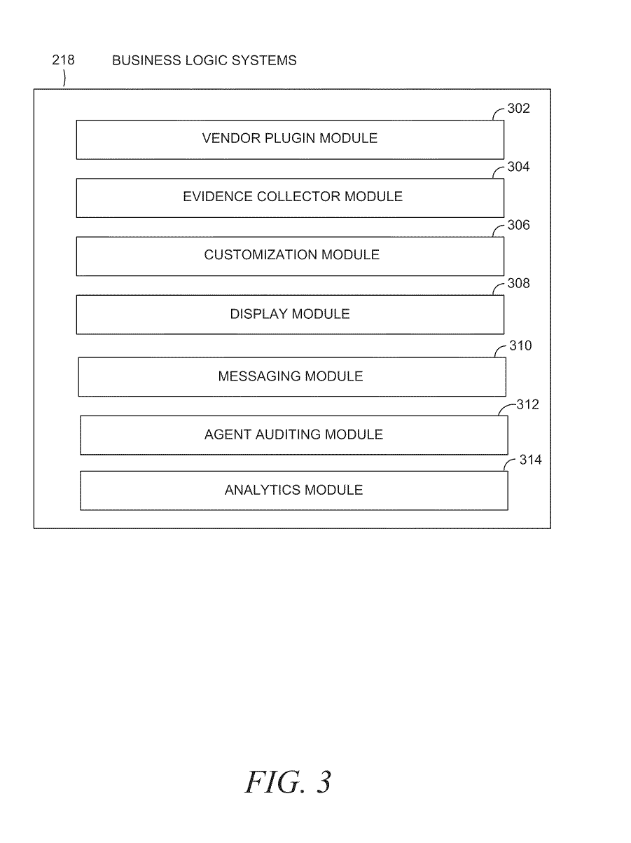

FIG. 3 is a block diagram of the business logic system 218 of the chargeback response tool, according to an example embodiment. The business logic system 218 comprises modules, including a vendor plugin module 302, an evidence collection module 304, a customization module 306, a display module 308, a messaging module 310, an agent auditing module 312, and an analytics module 314.

The vendor plugin module 302 receives data from the financial vendors 202 and may contain the vendor specific plugins 212, 214, 216. The vendor plugins 212, 214, 216 may be customized for a particular data format or data retrieval system. In an example embodiment, the vendor plugin 212, 214, 216 reads chargeback data for a particular financial vendor 202. In a further embodiment, the vendor plugin 212, 214, 216 may automatically fetch the chargeback data from the vendor server 204. The vendor plugin module 302 receives or fetches chargeback data from the vendor 202 and provides the chargeback data to other modules of the business logic system 218.

The evidence collection module 304 analyzes the chargeback data received by the vendor plugin module 302 and collects chargeback dispute evidence from the transaction system 234 to dispute the chargeback. In an example embodiment, the evidence collection module 304 will analyze the chargeback data for information identifying the transacting parties and the transaction. Transacting parties may be identified by, but not limited to, names of account holders, account identifiers, social security numbers, the transaction, or other personal data. The transaction may be identified through a time and amount of the transaction, the involved parties, a transaction identifier, and other identifying data. The evidence collection module 304 then may utilize the identifying information to query the transaction system 234 to collect the chargeback dispute data. The chargeback dispute data may include data about a party to the transaction. Such data may include reputation data, data about buyer activity, data about the goods or services provided, credit card agreement data, and past transaction history (e.g., a number of previous chargebacks or a time, amount, and size of previous transactions). In addition, the evidence collection module 304 may collect data from a user of the transaction system 324 (e.g., buyer or seller) or from an external system. For example, the evidence collection module 304 may seek additional information from the user and send a request for information via email or the transaction system 234 The evidence collection module 302 may also query an external system for evidence. For example, the United States Postal Service (USPS) may be queried to provide evidence that a package is successfully shipped to a given address on a certain date.

The chargeback data and the chargeback dispute data may then be analyzed by the customization module 306. The customization module 306 may contain templates for generating a chargeback dispute file. In an example embodiment, the customization module 306 allows creation of chargeback dispute templates for various scenarios, such as a unique template for different vendors. The chargeback dispute templates may also be customized to accommodate the chargeback data and chargeback dispute evidence. For example, if the chargeback dispute evidence indicates that the seller has poor reputation score the chargeback dispute template may be customized to accommodate such data. The customization module 306 may also allow an agent to determine what data should be automatically fetched from the transaction system and how such data will populate a response template.

In an example embodiment, the customization module 306 presents canned responses. Canned responses may include, but are not limited to, responses addressing a credit card on file, that a seller has closed their account, or citing a credit card agreement.

The display module 308 presents the chargeback data, chargeback dispute evidence, and a populated chargeback dispute template to an agent. The agent may then view and modify the populated chargeback dispute template. In an example embodiment, the agent may add or remove data from a populated chargeback dispute template. The agent may also determine whether to send the populated chargeback dispute template as the chargeback dispute file to the financial vendor. Additionally, the display module 308 may also display agent performance data and analytics information.

After an agent determines that a populated message template should be sent to the financial vendor 202, the messaging module 310 then prepares and creates a chargeback dispute file. In one embodiment, the messaging module 310 takes the chargeback dispute template and converts it to the chargeback dispute file. In an example embodiment, a chargeback dispute file may include chargeback dispute evidence for multiple chargeback transactions. The messaging module 310 communicates the chargeback dispute file to the financial vendor 202 through the vendor server 204. In an example embodiment, the messaging module 310 may communicate the chargeback dispute file through various methods, including, but not limited to, email, an API, a website, fax, mail, or an FTP server.

The agent auditing module 312 analyzes the performance of each agent. The agent auditing module 312 stores agent performance in an audit and reporting database. Agent performance data may include data on what cases an agent worked on, a rate of successfully disputing a chargeback, an amount of money recouped through successful disputes of chargebacks, and a number of pending chargebacks in process. The agent auditing module 312 may also record an amount of time spent on each chargeback case. Agents may have a unique login to access the chargeback response tool which allows the agent auditing module 312 to track individual agent performance. The agent auditing module 312 may also analyze the performance data by agent, type of chargeback, the financial vendor 202, type of report, time spent per case, and type of chargeback dispute information used. Thus, an agent's performance may be compared against other agents and viewed in terms of the type of chargeback case. The agent auditing module 312 may also determine which chargebacks should not be contested when the cost of dispute is greater than a potential amount of money returned. In an example embodiment, the agent auditing module 312 may measure an agent performance to ensure that service level agreements in regards to response time are being met.

The analytics module 314 further analyzes data stored in the audit and reporting database to determine which approaches used to dispute a chargeback are most effective. In an example embodiment, the analytics module 314 may analyze disputed chargebacks in terms of the chargeback dispute template used, the chargeback dispute evidence presented, and a source of the chargeback dispute evidence. Using this analysis, the analytics module 314 determines which approach is most effective for a particular financial vendor 202 or category of chargeback. The analytics module may also analyze disputed chargebacks in terms of financial vendor consistency in dealing with provided evidence to aid the merchant in obtaining fair and consistent treatment of dispute evidence.

In an example embodiment, inquiries regarding a transaction, such as an inquiry initiated by a buyer about a transaction involving his account, may be analyzed and treated as a chargeback, except that no funds are returned to the buyer account. For example, a buyer may inquire about a particular transaction and the chargeback response tool may similarly collected chargeback dispute data to provide to a financial vendor.

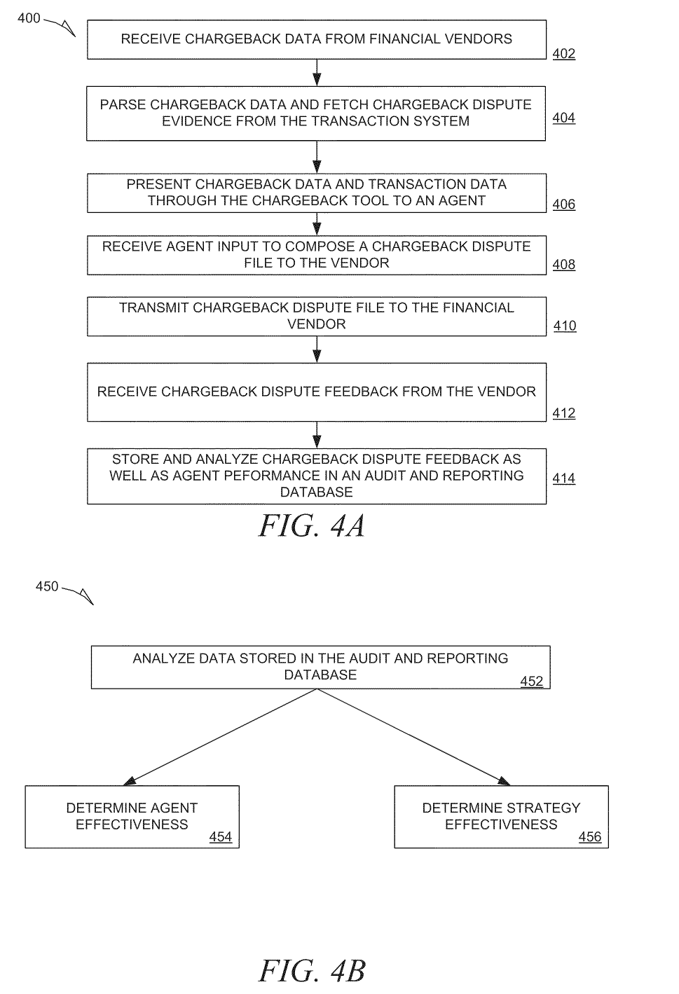

FIG. 4A is a process diagram illustrating a method 400 for generating a chargeback dispute file, according to an example embodiment. At operation 402, chargeback data is received from the financial vendor 202. The chargeback data may be data regarding disputable chargebacks. The chargeback data may be obtained using one or more process. For example, the chargeback data may be manually retrieved from the vendor server 204 or be automatically retrieved from the vendor server 204 associated with the financial vendor 202. Additionally, the chargeback data may be automatically pushed by the financial vendor 202 and received by the chargeback response tool system.

At operation 404, the chargeback data is analyzed and chargeback dispute evidence is fetched from the transaction system 234 that facilitated the transaction subject to a chargeback. The chargeback dispute evidence may include data relating to the parties of the transaction or relating to the transaction itself. The chargeback dispute evidence may be used to populate a chargeback dispute template.

At operation 406, the chargeback data and the chargeback dispute evidence is presented to the agent (e.g., agent 228). In an example embodiment, the chargeback dispute evidence is presented to the agent 228 that logs into the chargeback response system in the form of a chargeback dispute template. The chargeback response system may present the chargeback data and the chargeback dispute evidence after removing any personally identifiable and financially sensitive information. For example, names, social security numbers, credit card numbers, account numbers, or other sensitive data may not be presented to the agent 228.

At operation 408, the agent 228 prepares a chargeback dispute file. Specifically, the agent 228 may determine which chargeback dispute evidence should be included in the chargeback dispute file. Upon verification by the agent of the chargeback dispute template and the chargeback dispute evidence populating the chargeback dispute template, the chargeback dispute file is generated by the messaging module 310. In alterative embodiments, the agent may generate a chargeback dispute file without using the chargeback dispute template.

At operation 410, the chargeback dispute file is transmitted to the financial vendor 202. The chargeback dispute file may be transmitted through various methods, including, but not limited to, email, FTP, via a website, fax, mail, or transmission of data through an API.

At operation 412, chargeback dispute feedback is received from the financial vendor 202. The chargeback dispute feedback may indicate which of the disputed chargebacks are successfully disputed. The data may also indicate a reason why each dispute is successful. The chargeback dispute feedback may be received by the chargeback response tool in the same way the original chargeback data is communicated.

At operation 414 the chargeback dispute feedback may be analyzed or stored in an audit and reporting database, along with data concerning agent performance.

FIG. 4B is a process diagram illustrating an auditing and analytical method 450 of a chargeback response tool, according to an example embodiment. At operation 452, the data stored in the audit and reporting database is analyzed. The audit and reporting database may store information such as the chargeback dispute feedback, the chargeback data, and the chargeback dispute evidence. The audit and reporting database may also store data regarding agent performance, such as the time required to prepare a chargeback dispute file.

At operation 454, agent effectiveness may be evaluated. In an example embodiment, the effectiveness of the agent 228 may be analyzed in terms of how much time, and hence how much money, is spent in relation to the amount of money returned in a disputing a chargeback. It may be discovered that certain chargeback disputes are not economically feasible. An agent's performance may also be analyzed in relation to a particular type of feedback, a client, the type of dispute evidence presented, and other factors. For example, it may be discovered that a particular agent is more efficient in disputing chargebacks from a particular vendor or using a certain type of dispute evidence. The agent 228 may also be compared against other agents.

At operation 456, a particular strategy's effectiveness may be analyzed. For example, the use of a particular type of data or presentation of the dispute evidence may be compared to other strategies to determine overall effectiveness. More effective strategies may be emphasized for use by the agents 228, 230, 232.

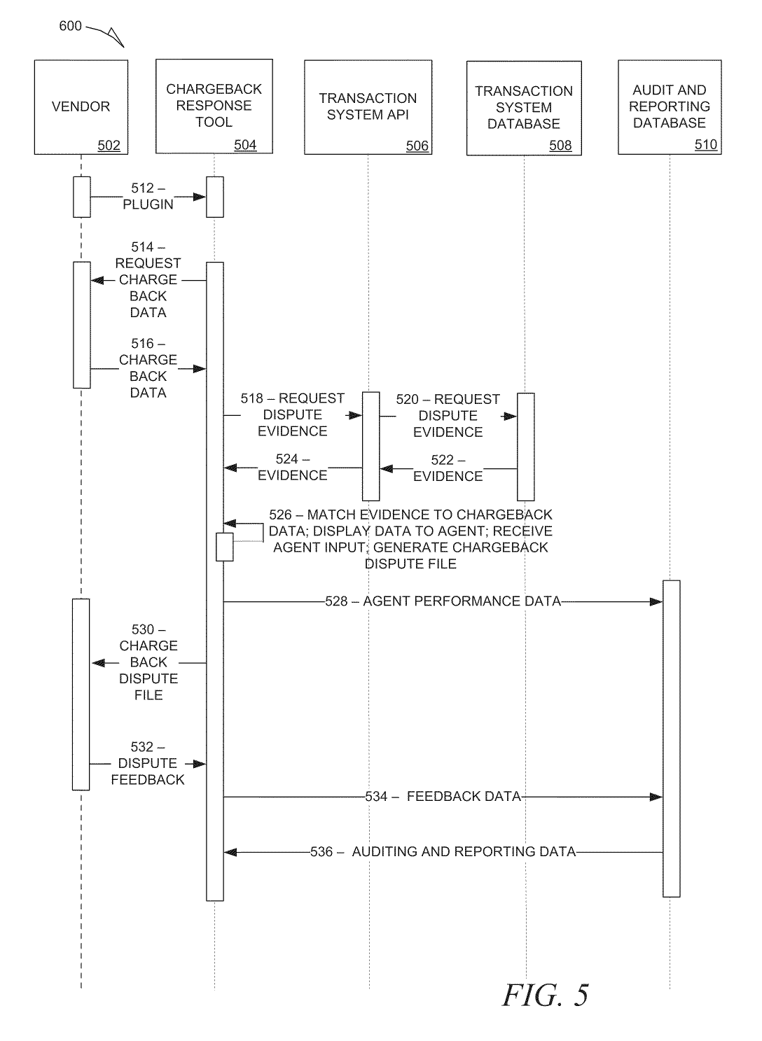

FIG. 5 is an interaction diagram illustrating an operation 500 of the chargeback response tool 504, according to an example embodiment. At operation 512, a vendor 502, sends configuration data sufficient to create a plugin to the chargeback response tool 504, where the plugin is able to either receive or retrieve chargeback data from the vendor 502. At operation 514, the chargeback response tool 504 requests the chargeback data from the vendor 502. The request may be a pull or push of the chargeback data from the vendor 502. At operation 516, the chargeback response tool receives the chargeback data from the vendor 502. The request and receipt of the chargeback data may occur through the plugin established at operation 512.

At operation 518, the chargeback response tool 504 automatically requests dispute evidence associated with the chargeback data from a transaction system through its API 506. The transaction system API 506 then queries one or more transaction system databases for relevant dispute evidence at operation 520. At operations 522 and 524, the requested chargeback dispute evidence is communicated to the transaction system API 506 and to the chargeback response tool 504, respectively.

At operation 526, the returned chargeback dispute evidence is matched to the chargeback data by the chargeback response tool and presented to an agent. The data may be presented through the chargeback dispute template for each chargeback dispute. The agent may then provide input about what evidence should appear in the chargeback dispute file by, for example, removing non-relevant evidence from the chargeback dispute template. Upon agent approval, a chargeback dispute file is generated. In one embodiment, the chargeback dispute file is generated by the messaging module 310 of the chargeback response tool.

At operation 528, agent performance for the particular chargeback dispute (e.g., time required to generate the chargeback response file) is stored in an audit and reporting database 510.

At operation 530, the chargeback response tool 504 communicates the chargeback dispute file to the vendor 502. In response, at operation 532, the chargeback response tool 504 receives chargeback dispute feedback from the vendor 502. The dispute feedback is then analyzed by the chargeback response tool 504 and communicated to the audit and reporting database 510 at operation 534. The dispute feedback may be analyzed in terms of agent performance (e.g., a ratio of wins versus losses).

Finally, at operation 536, the data stored in the audit and reporting database 510 may be analyzed to determine agent performance. The performance information is then presented via the chargeback response tool 504.

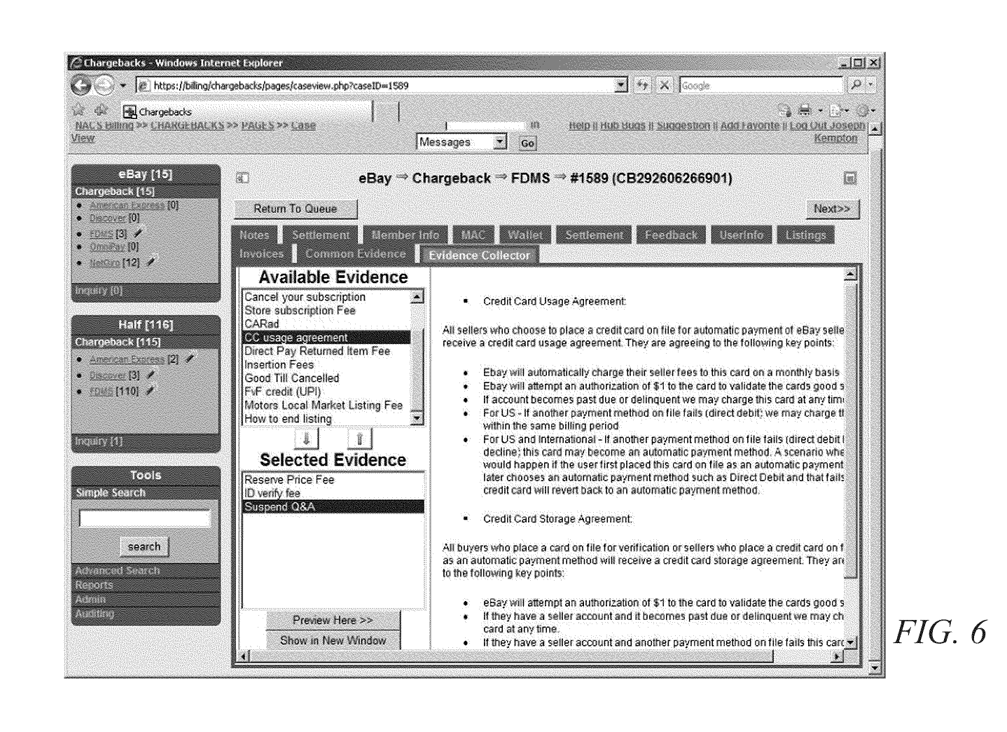

FIG. 6 is an example screenshot provided by a chargeback response tool providing available chargeback dispute evidence which may be used to generate a chargeback dispute file. In an example embodiment, the chargeback response tool is accessed through a web browser. Here, an agent is presented a list of available evidence. The available evidence is chargeback dispute evidence collected from the transaction system (e.g., transaction system 234). The agent may select evidence and view the evidence and a corresponding canned response. The agent may decide to use the evidence and add it to a selected evidence list, which comprises the evidence used to generate the chargeback dispute file.

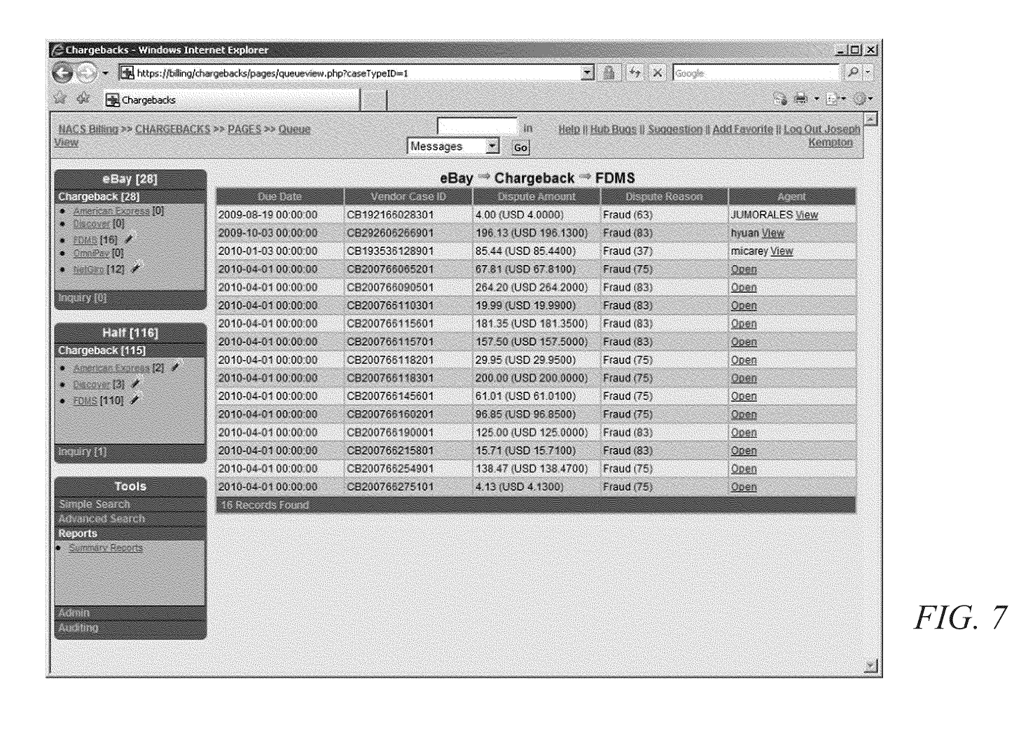

FIG. 7 is an example screenshot provided by the chargeback response tool presenting a queue of chargebacks for an agent to address. Confidential information relating to the chargebacks may be hidden and a due date, determined by a service level agreement, is listed next to each chargeback. The due date indicates a date by which the chargeback dispute should be settled by.

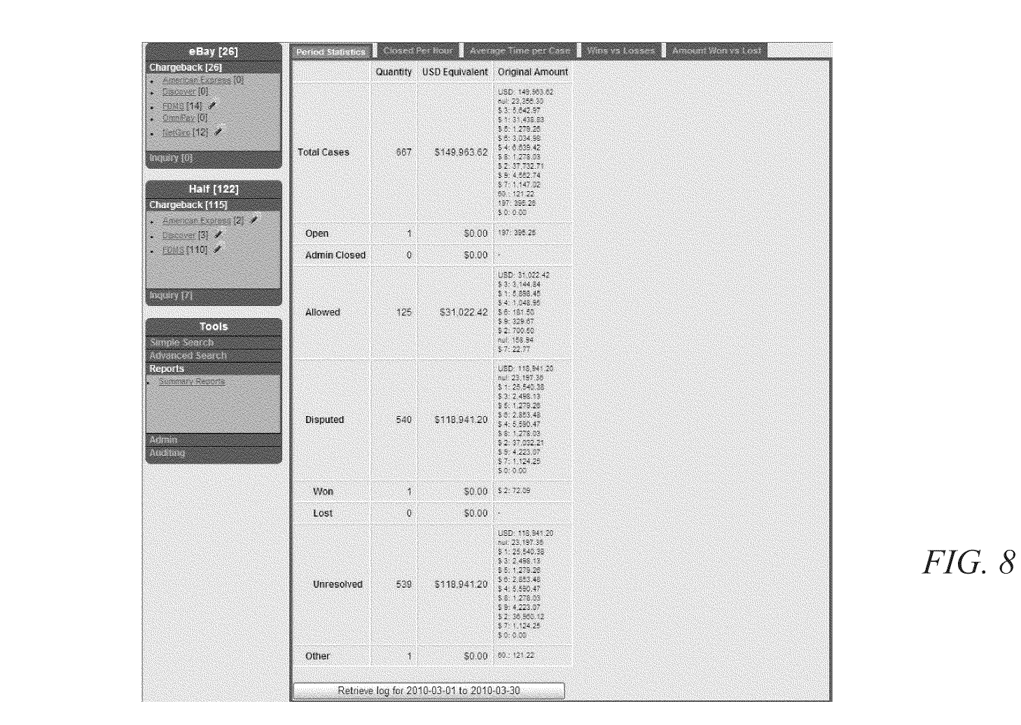

FIG. 8 is an example screenshot provided by the chargeback response tool presenting an agent auditing function. The chargeback response tool may audit an agent's performance. In this example, the agent's performance may be analyzed in terms of a number of open, closed, allowed, won, lost, and unresolved cases. Tabs also exist to analyze a number of chargebacks closed per hour, an average time per case, a ratio of wins to losses, and an amount of money won versus lost.

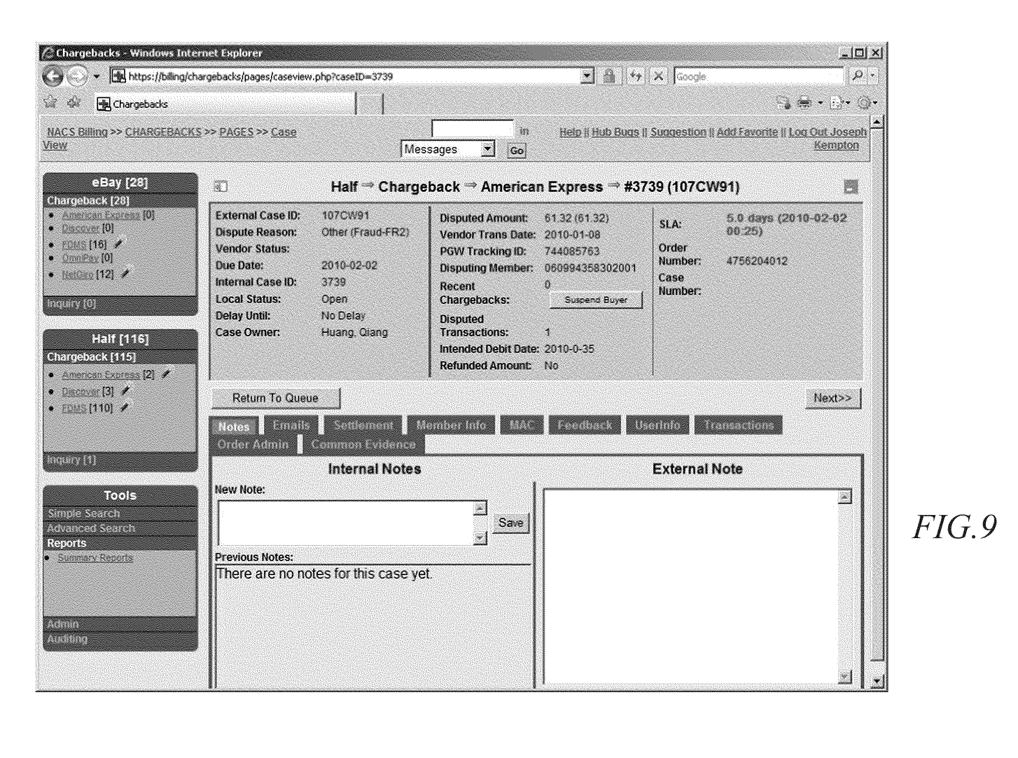

FIG. 9 is an example screenshot provided by the chargeback response tool presenting the details of a chargeback case. In this example, the evidence collection module 304 has already queried the transaction system 234 and sanitized confidential or sensitive information before displaying the details of the chargeback case to the agent. Details of the transaction, such as the transaction date and time, the disputed amount, and the dispute reason are listed. Also shown is data related to the parties of the transaction, including any other recent chargebacks.

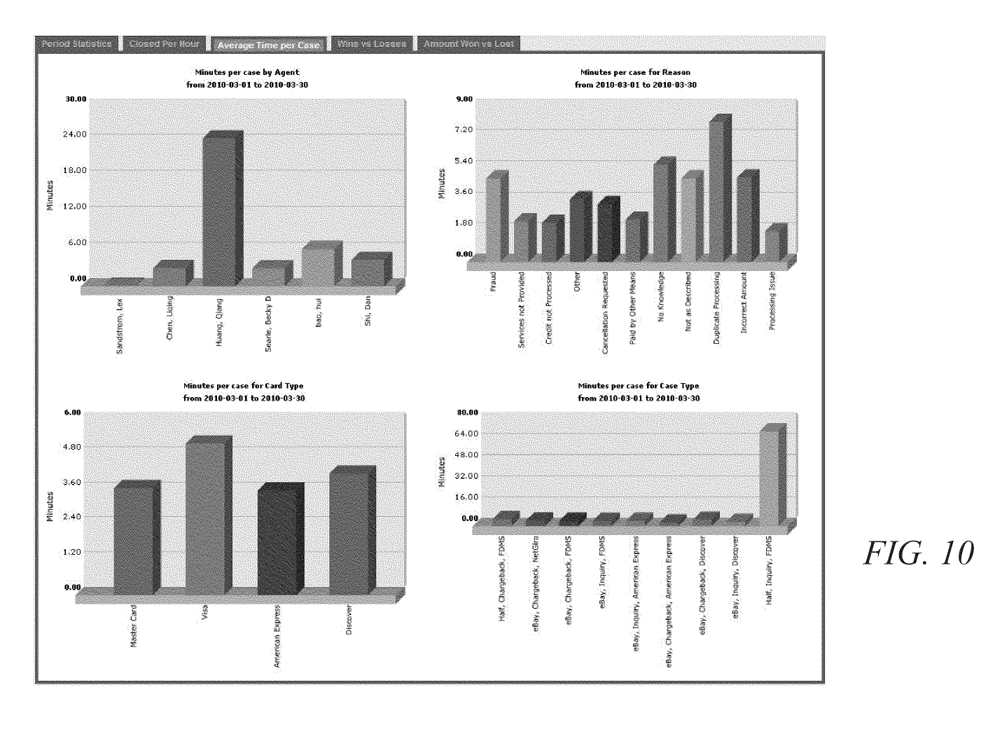

FIG. 10 is an example screenshot provided by the chargeback response tool presenting agent auditing information. Each agent's performance may be analyzed by minutes per case, minutes per reason of chargeback, minutes per card type, and minutes per case by case type.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Medium

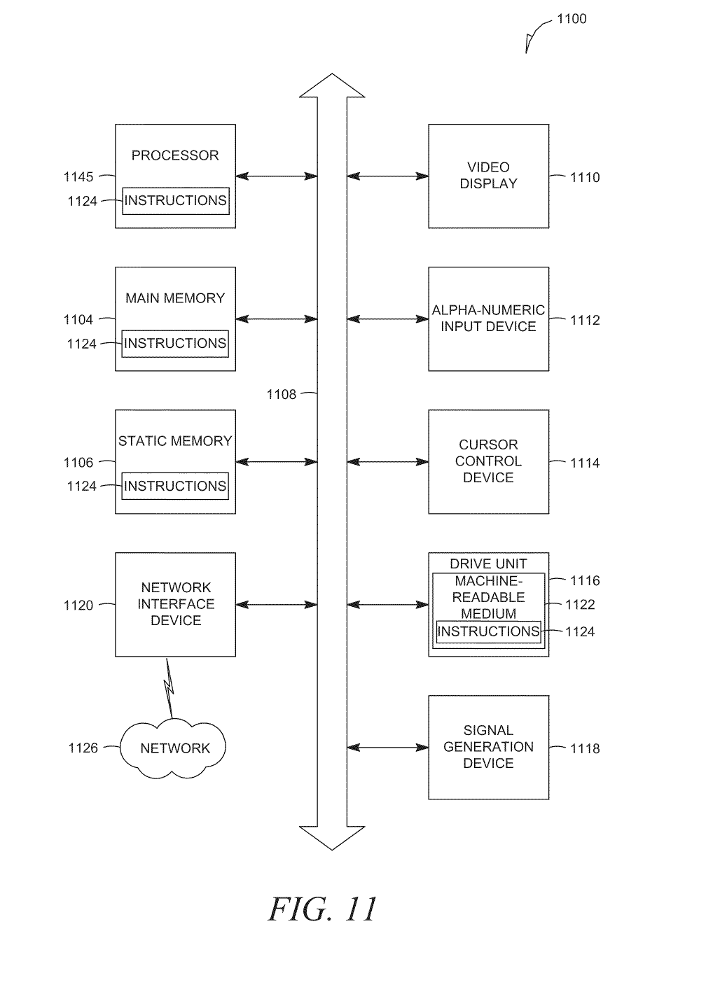

FIG. 11 is a block diagram of a machine in the example form of a computer system within which a set of instructions for causing the machine to perform one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU) a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., a mouse), a disk drive unit 1116, a signal generation device 1118 (e.g., a speaker) and a network interface device 1120.

The disk drive unit 1116 includes a machine-readable storage medium 1022 on which is stored one or more sets of instructions 1124 and data structures (e.g., software instructions) embodying any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable storage media. The instructions 1124 may further be transmitted or received over a network 1126 via the network interface device 1120.

While the machine-readable storage medium 1122 is shown in an example embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing, encoding or carrying a set of instructions for execution by the machine and that cause the machine to perform any one or more of the methodologies of the present invention. The term “machine-readable storage medium” shall accordingly be taken to include, but not be limited to, solid-state memories, and optical and magnetic media.

Thus, a method and system of a chargeback response tool has been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A system comprising:
an evidence collection module to analyze, using one or more processors, chargeback data received from a financial vendor for data describing a transaction and a party to the transaction, and querying a transaction system that facilitated the transaction for chargeback dispute evidence related to the transaction and the party;
a display module to populate a chargeback dispute template with the chargeback data and the chargeback dispute evidence; and
a messaging module to generate a chargeback dispute file from the chargeback dispute template.

2. The system as in claim 1, wherein the messaging module communicates the chargeback dispute file to the financial vendor.

3. The system as in claim 1, wherein the display module receives input modifying the chargeback dispute template.

4. The system as in claim 1, wherein the display module presents the chargeback dispute template to a terminal.

5. The system as in claim 4, wherein the display module does not display personally identifiable information.

6. The system as in claim 1, wherein the chargeback dispute evidence comprises a reputation score of the party.

7. The system as in claim 1, wherein the chargeback dispute evidence comprises data about other transactions of the party.

8. The system as in claim 1, further comprising a vendor plugin module to fetch the chargeback data from the financial vendor.

9. The system as in claim 1, further comprising a customization module to receive input to determine the chargeback dispute evidence collected from the transaction system to be used to generate the chargeback dispute file.

10. A method comprising:
analyzing chargeback data received from a financial vendor for data describing a transaction and a party to the transaction;
querying a transaction system that facilitated the transaction for chargeback dispute evidence related to the transaction and the party;
populating a chargeback dispute template with the chargeback data and the chargeback dispute evidence; and
generating a chargeback dispute file from the chargeback dispute template.

11. The method of claim 10, further comprising communicating the chargeback dispute file to the financial vendor.

12. The method of claim 10, further comprising receiving input modifying the chargeback dispute template.

13. The method of claim 10, further comprising presenting the chargeback display template to a terminal.

14. The method of claim 13, wherein personally identifiable information is not presented via the terminal.

15. The method of claim 10, wherein the chargeback dispute evidence comprises a reputation score of the party.

16. The method of claim 10, wherein the chargeback dispute evidence comprises data about other transactions of the party.

17. The method of claim 10, further comprising fetching the chargeback data from the financial vendor.

18. The method of claim 10, further comprising receiving input to determine the chargeback dispute evidence collected from the transaction system to be used to generate the chargeback dispute file.

19. A machine-readable storage medium in communication with at least one processor, the machine-readable storage medium storing instructions which, when executed by the at least one processor, performs a method comprising:
analyzing chargeback data received from a financial vendor for data describing a transaction and a party to the transaction;
querying a transaction system that facilitated the transaction for chargeback dispute evidence related to the transaction and the party;
populating a chargeback dispute template with the chargeback data and the chargeback dispute evidence; and
generating a chargeback dispute file from the chargeback dispute template.
